(19) United States
(12) Patent Application Publication
(10) Pub. No.: US 2014/0012895 A1
(43) Pub. Date: Jan. 9, 2014

(54) Universal Social Networking Interface for One-Click Posting From Mobile Devices

(71) Applicant: 2C Corp., New York, NY (US)

(72) Inventors: Frank Lieberman, New York, NY (US); Jim Kaus, Stewartsville, NJ (US); Paula Muller, Keyport, NJ (US); Urs Muller, Keyport, NJ (US)

(73) Assignee: 2C Corp., New York, NY (US)

(21) Appl. No.: 13/933,104

(22) Filed: Jul. 1, 2013

Related U.S. Application Data
(60) Provisional application No. 61/666,911, filed on Jul. 1, 2012.

(51) Int. Cl. H04L 29/08

(52) U.S. Cl. CPC H04L 67/02
USPC 709/203

(57) ABSTRACT

The present invention is a method to simplify the process of sharing location and/or event specific information or content with friends and other consumers of the information. The process of sharing the information is easily and automatically made possible through the consumer's portable communication or computing devices, such as a mobile smart phone or tablet. The shared content provides a link to the location specific information or content where the link can be posted automatically to an internet site such as a social networking site.

### CROSS REFERENCE TO RELATED APPLICATIONS

This application claims the benefit of U.S. Provisional Patent Application No. 61/666,911.

### BACKGROUND OF THE INVENTION

Social networking sites, such as Facebook, allow users of the site to post information about themselves in real time. Users will often use their mobile computing devices such as smart phones or tablets to post up-to-the-minute status information about themselves which may include details, photos or video clips just entered while still at a specific location. User's may take a picture of a particular location, perhaps a photo of themselves with a tourist location in the background, and post the picture immediately to their social networking site (their “wall” on Facebook, for instance) in order to make their friends aware of where they are at and what they are doing.

It is desired to provide an easy to use method of conveying site specific information and content to a user when they are at landmark or other locations of interest so that the information is automatically provided for posting onto a social networking site with minimal steps required for user input.

### BRIEF SUMMARY OF THE INVENTION

The present invention is a method of providing location specific information or content to a consumer of the information so that the information is easily and automatically made available through the consumer's portable communication or computing devices, such as a mobile smart phone or tablet, and further provides a link to the location specific information or content where the link can be posted automatically to an internet site such as a social networking site.

An example of the present invention is an implementation that allows visitors to a place, event, tour, or other venue to post the venue's on-line presence on their social networking page(s)from a mobile device with essentially one click. For instance, assume company A creates a web site for live streaming video, chat, and/or other services for an event. Company A may wish to advertise this web site. Many visitors attending the event may wish to let their friends know that they are in attendance at the event. The present invention lets the visitor (user) automatically add a posting to their social network page (“wall”) with a link to the event web site. This is a convenient and simple way for the user to add a relevant post to their social network page. Further it leads to the direct and possibly viral marketing of Company A's web site.

### BRIEF DESCRIPTION OF DRAWING VIEWS

The foregoing and other objects, features and advantages of the invention will become more fully understood from the following description of the preferred embodiments of the invention as illustrated in the accompanying drawings in which like reference characters refer to the same parts throughout different views.

FIG. 1 is a system overview showing the specific components of the present invention, including the universal social network interface web site (box left) and the HTML5 web application.

FIG. 2 is a flow diagram showing the typical steps in present invention.

FIG. 3 is an example of a QR Code (quick response code).

FIG. 4 is an example of a poster that may appear at a location of interest, such as the Circle Line tour boat in New York City.

FIG. 5 is an example of a social network personal page where the user has just posted the location specific link to the page. The URL appears within the post.

FIG. 6 is an example showing the new window that appears when someone viewing the social network personal page then clicks on the embedded link.

FIG. 7 is a sketch of an example social media experience according to the present invention.

### DETAILED DESCRIPTION OF THE INVENTION

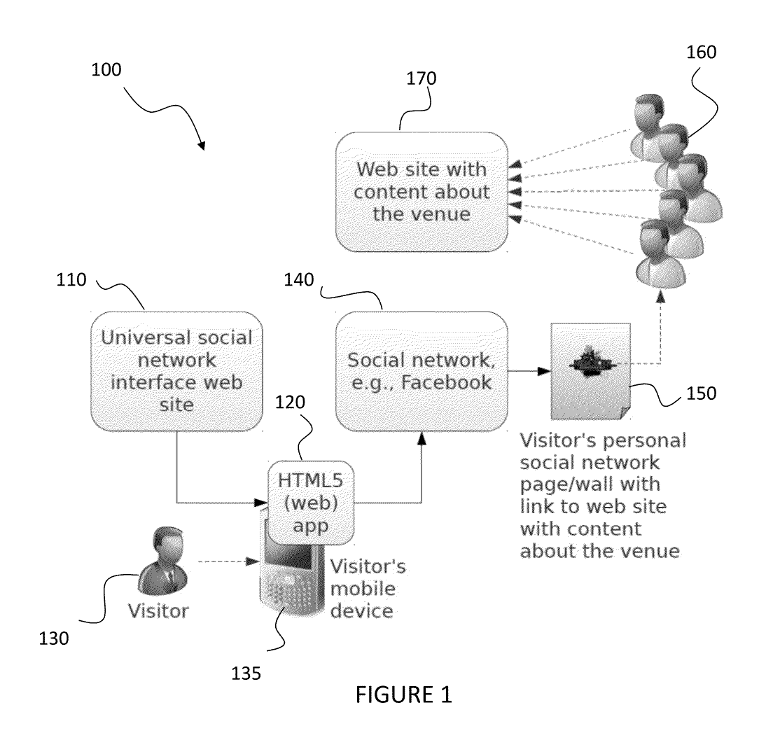

Referring now to the drawings and in particular to FIG. 1, wherein there is illustrated a block diagram of typical functionality and decision logic of one version of the present invention 100, a detailed description of the various functionality and decision logic is provided herein.

FIG. 1 shows a system overview of a typical implementation of the universal social networking interface 100. The invention consists of a universal social network interface web site 110 which may host a HTML5 web app 120 that is down-loaded to the visitor's 130 (or user's) phone 135. The HTML5 app 120 then interacts with an existing social network site 140 such as Facebook. When the user agrees to the prompts, the HTML5 app 120 posts an entry to the visitor's personal page 150 with a link to the web site 170 with the actual content of the venue. All friends 160 who access the visitor's personal page 150 see the link and can get to the venue web site 170 with one click.

Instead of or in addition to placing a link to the web site 170 providing the content of the venue (such as streaming video), an alternative would be to place the venue content (such as streaming video) directly into the visitor's personal social network page 150. In this case, the visitor's friends 160 could see the live venue content directly on the visitor's personal page 150 (perhaps for a limited duration) and they do not have to select a link to navigate to the venue web page 170. The visitor 130 could be offered to select between these two options when asked for permission by the web application 120. An additional feature is to allow the content to be available from the visitor's personal social network page 150 on demand, such that video or other content that is specific to venue, event and/or time is available at a later time through the personal social network page 150.

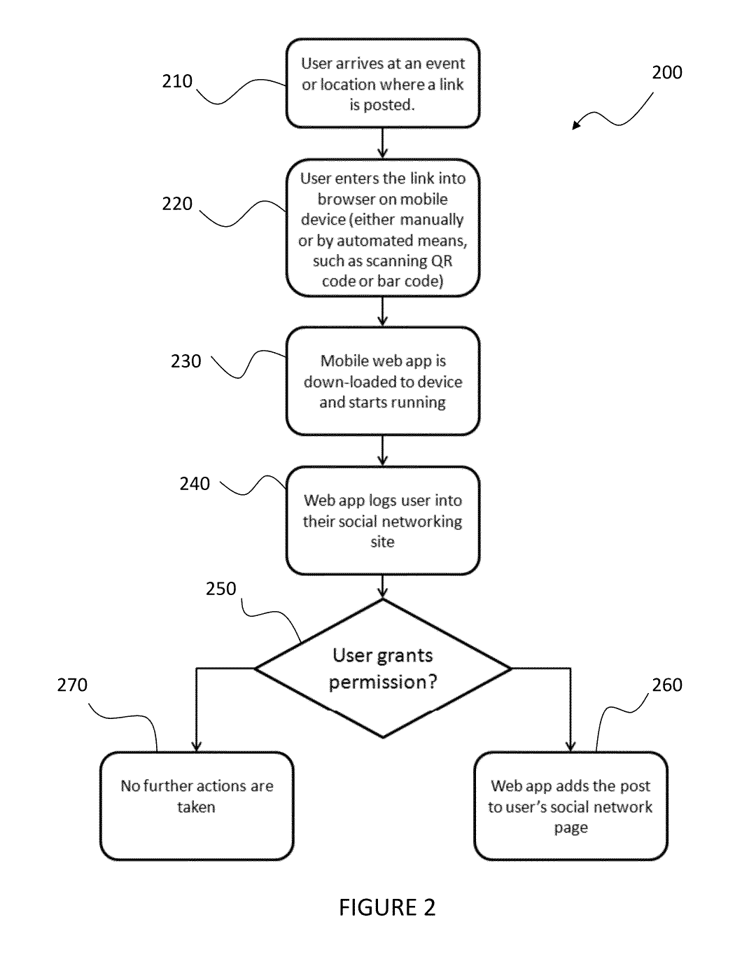

Referring now to FIG. 2, the present invention is demonstrated by the flow diagram 200.

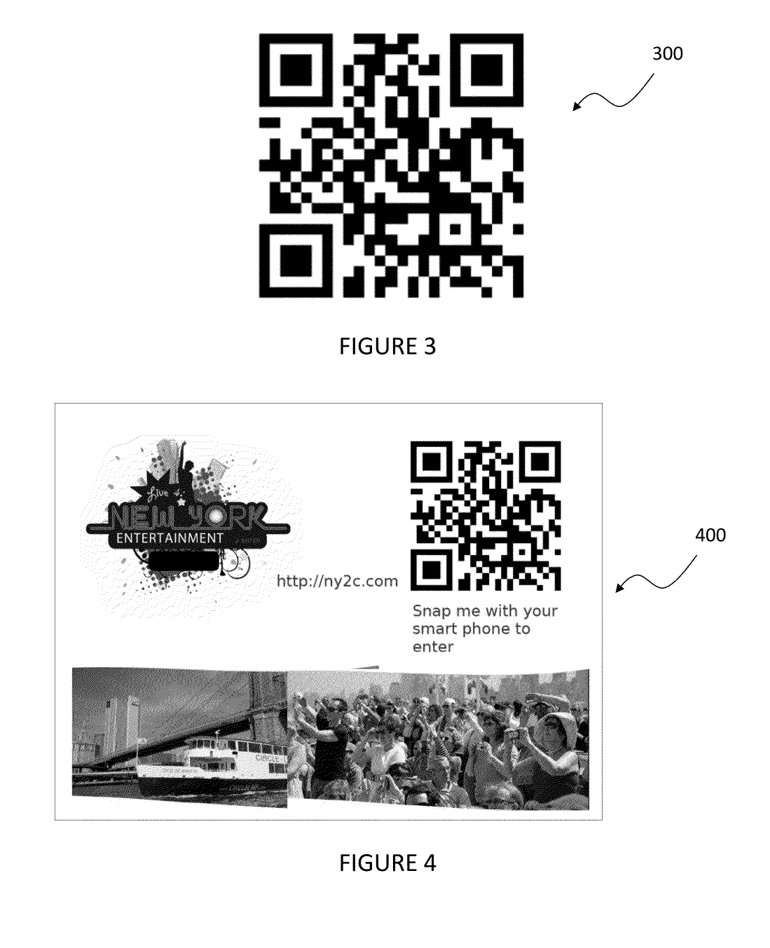

In a first step 210, a user arrives at a location where a link is posted, where the link may take the form of a URL, QR code or any other form of unique identification to an online content source. A QR Code 300 (quick response code) is depicted in FIG. 3 and is a two-dimensional barcode that can be easily scanned and can be decoded to extract information, such as a URL address.

In a second step 220, the link information is entered into the user's mobile device (such as smart phone or tablet) either through manual entry by the user or ideally through a more automated process, such as scanning an image of the link (URL, QR code, other identifier) or perhaps through a location sensitive RF signal (Bluetooth, WiFi, etc.) or through a geolocation based functionality (GPS or other location sensing method). The code can be scanned by the user with their mobile device to automatically enter the URL with location specific information. The result of identifying the link associated with a given location is that the user is connected 230 via the mobile device to a universal social network interface web site which manages the link between the user's device and the location specific information or content.

Once connected to the universal social network interface web site, the user is logged into their social networking site 240, such as Facebook. If the mobile device has not already been setup to provide credentials for logging into the site, these may need to be entered by the user at this time.

The universal social network interface prompts the user 250 to select whether or not the user would like to add a post about the current event or location to their personal page on the social network.

If the user accepts the prompt to post 260, then the location specific information is posted to the user's social network page. If permission is not granted, then 270 no further action is taken.

In another embodiment of the present invention, a visitor enters a venue and sees a poster with a URL and QR code (essentially a 2D bar code) on it.

The visitor either enters the URL into their mobile device (smart phone or tablet)or takes a picture of the QR code from their mobile device using a QR code reader app. In either case, the visitor gets connected to the universal social network interface web site which is at the core of this invention.

The social network interface web site down-loads an HTML5 (web) app to the mobile device.

The HTML5 app logs the user into their social networking site such as Facebook. The social networking site will ask for the user credentials (ID, pass-word), if the user has not previously entered and stored that information.

The HTML5 app asks user if he/she would like to add a post about this event to their personal page on the social network.

If user accepts (only “one click” is required to accept), the HTML5 app adds the post to the user's social network page.

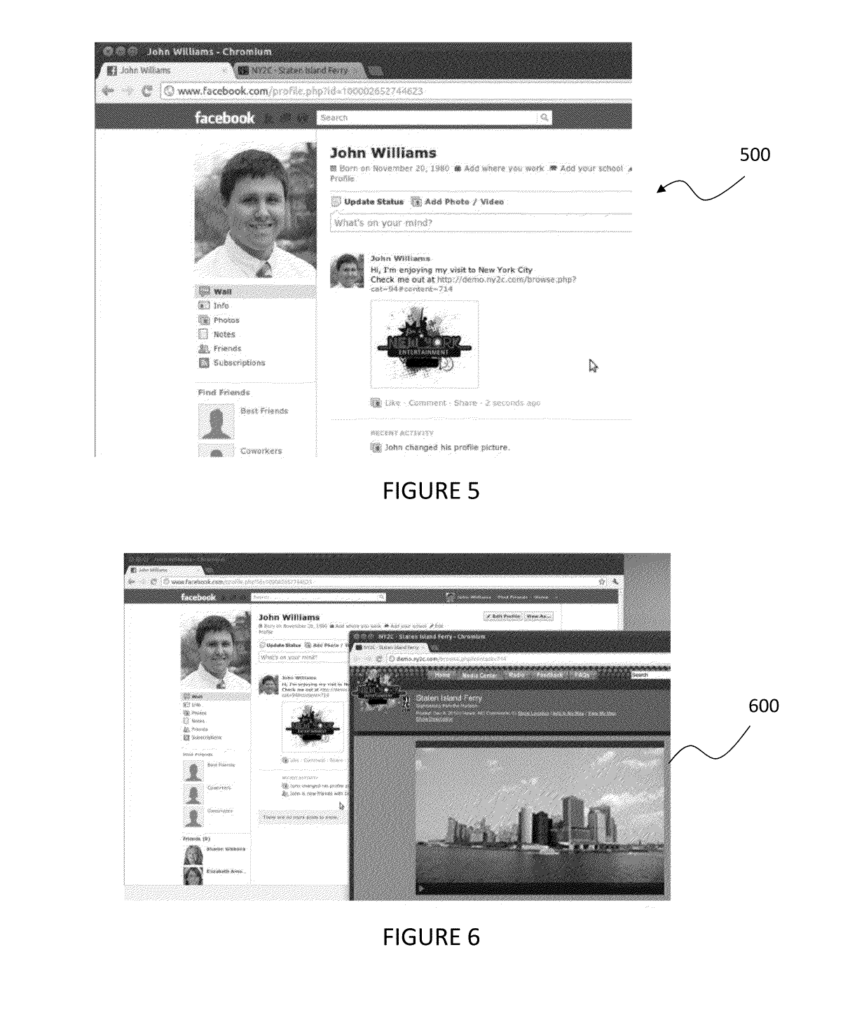

FIG. 5 shows a typical representation of a social network personal page 500 where the user has just posted a location specific link to the page. FIG. 6 is an example showing the new window 600 that appears when someone viewing the social network personal page then clicks on the embedded link. In this example of the Circle Line tour, the link displays the streaming video from the webcam installed on the boat. The person viewing the link now sees a live view from the location where the user is at.

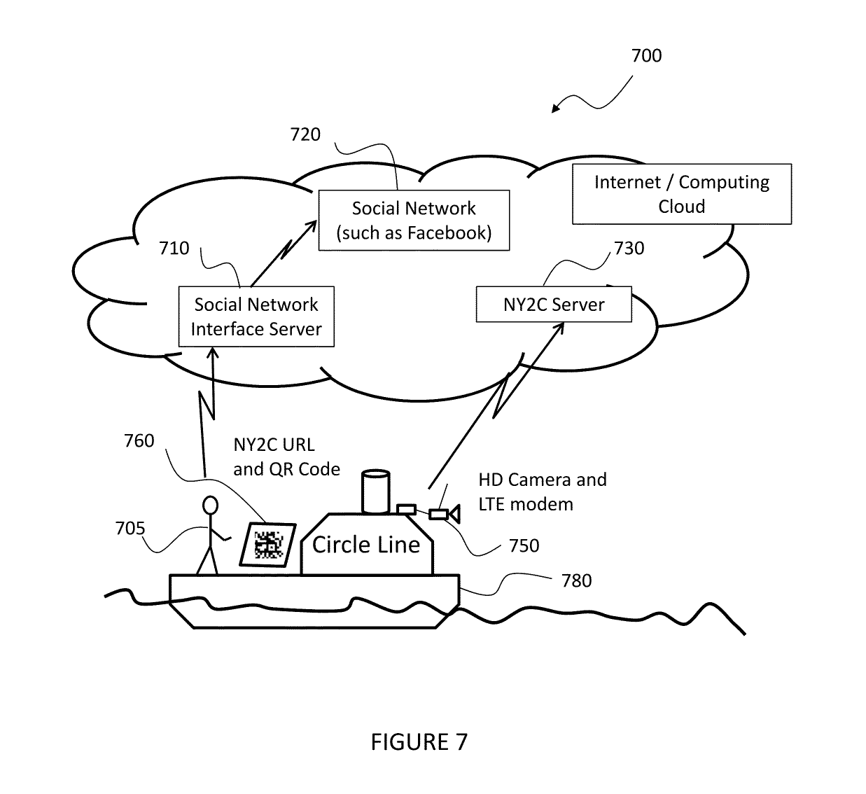

In FIG. 7, a specific example of a social network experience according to the present invention is shown, where the example here is a tourist attraction such as the Circle Line boating tour 700 on the waterways of New York City. In this experience, the passenger 705 (or user) on the boat 780 scans a code 760 or enters a URL is connected to their social media site through the social network interface server 710, and is prompted to login to their social media site 720. The server 710 posts the local content (here the URL for NY2C server 730 site) on the social network page. The content that is provided may be, for example, streaming video from an HD camera providing content through an LTE modem 750.

It can be appreciated that the specific implementation may change without loss of generality. Any form of unique identifier for web based content can be used, though current examples include URLs and QR codes. Also, any form of entry may be used, including manual entry, speech based entry, camera entry, RF entry, or geolocation based entry. “QR codes” are just one of several options with which this invention could be implemented such as to automatically enter the URL to get to the web application. Other technologies may serve the same purpose without loss of generality in the inventive subject matter and may include bar codes, near field communications (NFC) or other means.

Also, while social network sites are referenced herein, especially related to personal pages within social network sites, it is apparent that any content hosting service could be the destination for posting the location specific information, content of links. This may include social network pages, blogs, chat rooms, group text messaging, personal web pages, greetings on answering machines, ringback tones, video ringback, or other information hosting services.

Distribution of the audio and/or video content may be by any suitable technology, which may include wireless distribution (3G, 4G, WiFi, satellite distribution, etc.) or copper/optical transmission line.

The present invention will work generally with any method of internet based posting or social media site, including current social media implementations such as Facebook, Twitter, Foursquare, etc.

One benefit of the present invention is that it makes it extremely simple to share the current experience of being at a location or event with friends on a social network. The process may consist of taking a picture of the QR code with the cell phone camera or by entering a short URL into the phone's browser.

Friends of a visitor see where he/she currently is and what he/she is doing.

The operator of a location or event specific web site with content about the location or event will benefit from the increased amount of direct word-of-mouth marketing generated by this invention. If friends forward the links to other friends, then the marketing could even become viral.

The invention can be extended in a number of ways to make the service more attractive, valuable, and/or unique. Examples are provided below.

The service could create a personal stream for each visitor by superimposing their picture into the live video stream. Users can choose to use their existing Facebook (or other social media) picture or they can take a new picture of themselves from their smart phone and upload it.

The service could include the ability to chat or blog. Users can enter text on their smart phone describing anything they like to express and add that to their personal stream.

The service could allow the inclusion of audio and video the user captures from their smart phone. For example, users can videotape themselves from a front camera of a smart phone and comment what they see or experience. They can stream that live to the venue operator web site from where it gets superimposed on their personal stream. This gives users the ability to create live reporting that resembles newscasts or breaking news.

The service could include an application that loads onto the mobile device and has location based notification of landmarks. This may either update social network site automatically or prompt the user to upload when close to the landmark. For instance, this could be a previously prepared map with tourist locations, perhaps an overlay on an internet accessible map (such as Google maps) so the user can self-navigate to landmarks. The landmarks locations are preinstalled by location. The user may be able to turn on and off certain categories of landmarks, or just go through a list and select only the landmarks of interest. Then when the user approaches the landmark, the geolocation function of the mobile device causes a notification to the user, such as a vibration or sound along with a pop up message on the user interface of the mobile device, to signify that a landmark of interest is nearby. The user can then choose to automatically post the location specific information on their personal social network site.

The above applications can be extended with the ability to use computer vision possibly in combination with geolocation and directional information to recognize landmarks. A visitor could take a picture, for example, of the Empire State Building. The app recognizes the landmark and offers the user the same options they would have if entering the landmark through other means (QR code, URL, etc.).

Content provided at a location of interest may include user selectable text that gives description of the location that is suitable for posting. For example, at a historical landmark, the user may have a choice of posting a brief history about the location or landmark, a more detailed history, or perhaps an item of trivia related to the site.

Content may include photos or video of the location and/or of the user at the location.

The concept can be applied to activities in general and is not limited to specific locations or events. For example, watching a TV show could be such an activity. The TV program can offer a URL, display a QR code or provide other means to let viewers share information about the TV program with their friends.

One implementation of the invention is to provide the ability for a user to enter a code or link posted or otherwise made available at a given location (either visually posted for manual or automatic entry into a mobile electronic device, such as by scanning a QR code, or by another means such as a wireless link to the mobile device) and obtain audio and/or video content from a audio/video device installed at the location, such for posting directly to a social network site. For instance, a video or still camera may be installed at a location such as at a tourist site. The user wishes to have their picture or video taken from the vantage point of the installed camera, which may in general be installed in an optimal location for purposes of capturing a particularly scenic view at the site, an otherwise inaccessible vantage point, or from a vantage point that allows the user to position themselves in the frame of the photo or video at the time the photo or video is captured specifically for said user. Functionality may be provided to allow the user to select the capture time of a photo or the capture range of time for a video. For instance, the user may scan the code at the site and instantly be provided the photo or video from the source at the time the code is scanned. Alternatively, there may be a prescribed time lag between scanning the code and the capture time, such as a 30 second time lag to allow the user to position themselves in the field of view of the camera before the capture occurs. Alternatively, when the code is scanned, an application may be loaded on the user's mobile device providing the capability to select the exact capture time by subsequently tapping the touch screen of a smart phone, for instance. The photo, video or audio content that is captured at a specific time for the specific user is provided for posting to a social network page, other internet content site or perhaps directly to the user's mobile device. The photo, video or audio may also be sent electronically, such as by email or text/MMS messaging, to the user. Or a link to the photo can be sent electronically to user for later downloading. The camera may have temporary storage with time stamped photos and video in order to facilitate streaming content to one or more users in response to time specific requests for content as just described. The same photo or video may be provided to multiple users depending on how many users request content from a specific time or time range.

In another application of the present invention, the user scans a QR code near a window camera, a still image or short video clip of the user from the camera at that time and location is automatically uploaded to social media site of choice. Instead of scanning the code with phone on camera, user “bumps” nfc chip or related technology for same results.

What is claimed as the invention is:

1. A universal social network interface method for automated posting of content from mobile devices comprising the steps:
a user arrives at an event or location where a site-specific link is provided;
the user enters the link into the browser of a mobile device using an input means;
a mobile web application is downloaded to the mobile device;
the mobile web application executes on the mobile device;
the mobile web application connects the user to their social networking site;
the user is prompted to grant permission for the site-specific link to be posted to the user's social network page;
the user grants permission; and
the web application adds the site-specific link to the user's social network page.

2. A universal social network interface method for automated posting of content from mobile devices according to claim 1, where the input means is by manual entry.

3. A universal social network interface method for automated posting of content from mobile devices according to claim 1, where the input means is automated by scanning a code.
